(19) United States
(12) Patent Application Publication
(10) Pub. No.: US 2026/0304465 A1
(43) Pub. Date: Oct. 1, 2026

(54) BASE STATION DEVICE, TERMINAL, AND INTERFERENCE CANCELATION METHOD

(71) Applicant: SK TELECOM CO., LTD., Seoul (KR)

(72) Inventors: Sang Hoon CHO, Seoul (KR); Chi Young CHOI, Seoul (KR)

(21) Appl. No.: 18/880,348

(22) PCT Filed: Aug. 1, 2023
(86) PCT No.: PCT/KR2023/011199

§ 371 Date: Dec. 31, 2024

(30) Foreign Application Priority Data
Aug. 11, 2022 (KR) 10-2022-0100428

(51) Int. Cl. H04W 72/541; H04B 17/318; H04B 17/345; H04B 17/391; H04L 5/14; H04W 72/0453

(52) U.S. Cl. CPC H04W 72/541; H04B 17/345; H04B 17/3912; H04L 5/14; H04W 72/0453; H04B 17/328

(57) ABSTRACT

The present disclosure relates to an interference removal method according to application of a subband non-overlapping full duplex (SBFD) technology.

### TECHNICAL FIELD

The present disclosure relates to an interference removal method arised from applying a subband non-overlapping full duplex (SBFD) technology.

This application claims priority to Korean Patent Application No. 10-2022-0100428, filed Aug. 11, 2022, whose entire disclosures are hereby incorporated by reference.

### BACKGROUND ART

In 5G systems, known as new radio (NR), using higher frequency bands and wider bandwidths compared to existing LTE systems, a function capable of simultaneously using Tx and Rx by using full duplex communication, based on an existing TDD scheme is being discussed.

The function is named subband non-overlapping full duplex (SBFD) as a technology for separately transmitting downlink (DL) and uplink (UL) in each frequency subband through frequency segmentation, in consideration of interference removal being difficult when the same frequency is simultaneously used in Tx and Rx operations.

In this SBFD technology, it is possible to allocate uplink resources to consecutive slot intervals and thus improve the problems of existing TDD, such as lack of uplink resources, latency, coverage, and degradation of uplink speed.

However, simultaneous transmission of downlink (DL) and uplink (UL) in frequency subbands is supported.

Therefore, downlink and uplink exist at the same time point at different frequency positions, and thus self-interference (SI) may occur in a boundary frequency band between downlink and uplink.

In other words, downlink has a relatively higher signal strength compared to uplink and thus may interfere with uplink of an adjacent frequency band, and such uplink interference may, in severe cases, even prevent call processing in uplink.

### DISCLOSURE OF INVENTION

### Technical Problem

The present disclosure has been made to solve the above problem, and an aspect to be achieved in the present disclosure is to minimize self-interference (SI) occurring between downlink and uplink when a subband non-overlapping full duplex (SBFD) technology is applied.

### Solution to Problem

In accordance with the above aspect, a base station device according to an embodiment of the present disclosure includes a memory including an instruction and a processor, wherein the processor is configured to, by executing the instruction, calculate uplink interference that is interference from a downlink to an uplink, arised from simultaneous use of the downlink and the uplink in frequency subbands, and differently determine a range of a guard band corresponding to a boundary frequency band between the downlink and the uplink according to a magnitude of the uplink interference.

Specifically, the uplink interference may be calculated based on a cross-link interference (CLI)-RSSI measured and reported by a terminal according to an entry into a pre-configured I1 event (Event I1).

Specifically, the processor may be configured to configure a condition for entry into the I1 event (Event I1) and provide the condition to the terminal, and the condition for entry may be configured based on ambient interference measured in the uplink in an idle state of the base station device, which is a state where interference of the downlink has been removed.

Specifically, the processor may be configured to, in case that the magnitude of the uplink interference exceeds a threshold, determine the number of guard band resources (guard band RBs) allocable to the guard band, based on the magnitude of the uplink interference in order to expand the guard band, and in case that the magnitude of the uplink interference is smaller than the threshold, determine the number of guard band resources (guard band RBs) allocable to the guard band and configured based on the magnitude of the uplink interference in order to reduce the guard band.

In accordance with the above aspect, a terminal according to an embodiment of the present disclosure may include a memory including an instruction and a processor, wherein the processor is configured to, by executing the instruction, in case that a downlink and an uplink are simultaneously used in frequency subbands, for calculation of uplink interference that is interference from a downlink to an uplink, measure a cross-link interference (CLI)-RSSI value, and transmit the CLI-RSSI value to a base station device so as to support the base station device to differently determine a range of a guard band corresponding to a boundary frequency band between the downlink and the uplink according to a magnitude of the uplink interference calculated based on the CLI-RSSI value, and a resource in the guard band is excluded from resources for measurement and transmission of the CLI-RSSI value.

In accordance with the above aspect, an interference removal method performed by a base station device according to an embodiment of the present disclosure includes calculating uplink interference that is interference from a downlink to an uplink, arised from simultaneous use of the downlink and the uplink in frequency subbands, and differently determining a range of a guard band corresponding to a boundary frequency band between the downlink and the uplink according to a magnitude of the uplink interference.

Specifically, the uplink interference may be calculated based on a cross-link interference (CLI)-RSSI measured and reported by a terminal in accordance with an entry into a pre-configured I1 event (Event I1).

Specifically, the method may further include configuring a condition for entry into the I1 event (Event I1) to provide the condition to the terminal, wherein the condition for entry is configured based on ambient interference measured in the uplink in an idle state of the base station device, which is a state where interference of the downlink has been removed.

Specifically, the determining may include, in case that the magnitude of the uplink interference exceeds a threshold, determining the number of guard band resources (guard band RBs) allocable to the guard band, based on the magnitude of the uplink interference in order to expand the guard band, and in case that the magnitude of the uplink interference is smaller than the threshold, determining the number of guard band resources (guard band RBs) allocable to the guard band and configured based on the magnitude of the uplink interference in order to reduce the guard band.

### Advantageous Effects of Invention

According to device and a resource configuration method of the present disclosure, when a subband non-overlapping full duplex (SBFD) technology is applied, a range of a guard band corresponding to a boundary frequency band between downlink and uplink may be adjusted according to the magnitude of uplink interference, thereby minimizing self-interference (SI) occurring between downlink and uplink.

### BRIEF DESCRIPTION OF DRAWINGS

FIG. 1 is a diagram illustrating an example of self-interference (SI) according to an embodiment of the present disclosure;

FIG. 2 is a diagram illustrating an example of a full duplex communication environment according to an embodiment of the present disclosure;

FIG. 3 is a diagram illustrating an example of a configuration of a base station device according to an embodiment of the present disclosure;

FIG. 4 is a diagram illustrating an example of a guard band determination method according to an embodiment of the present disclosure;

FIG. 5 is a diagram illustrating an example of a configuration of a terminal according to an embodiment of the present disclosure; and

FIG. 6 is a flowchart illustrating an interference removal method according to an embodiment of the present disclosure.

### BEST MODE FOR CARRYING OUT THE INVENTION

Hereinafter, various embodiments of the present disclosure will be described with reference to the accompanying drawings.

The present disclosure handles a subband non-overlapping full duplex (SBFD) technology.

In LTE communication systems, as the types of communication services and required transmission speeds diversify, the expansion of LTE frequencies and the evolution toward 5G communication systems are actively progressing.

In 5G systems, a function capable of simultaneously using Tx and Rx by utilizing full duplex communication, based on an existing TDD scheme is being discussed in 3GPP Release 18.

The function is named subband non-overlapping full duplex (SBFD) as a technology for separately transmitting downlink (DL) and uplink (UL) in each subband through frequency segmentation, in consideration of interference removal being difficult when the same frequency is simultaneously used in Tx and Rx operations.

In this SBFD technology, it is possible to allocate uplink resources to consecutive slot intervals and thus improve the problems of existing TDD, such as lack of uplink resources, latency, coverage, and degradation of uplink speed.

However, as described above, when simultaneous transmission of downlink (DL) and uplink (UL) in frequency subbands is supported, downlink and uplink exist at the same time point at different frequency positions.

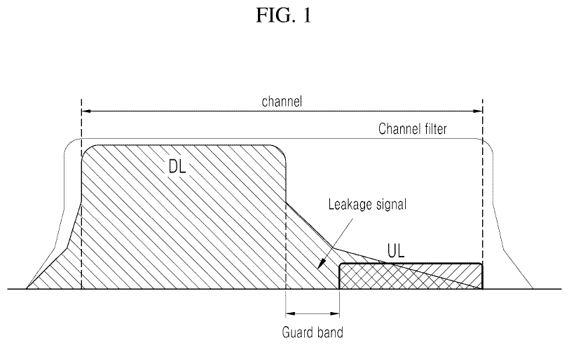

Accordingly, for example, self-interference (SI) in a boundary frequency band between downlink and uplink may occur as illustrated in FIG. 1.

In other words, downlink has a relatively higher signal strength compared to uplink and thus a leakage signal from downlink may interfere with uplink of an adjacent frequency band.

Such uplink interference may, in severe cases, even prevent call processing in uplink.

Meanwhile, in order to simultaneously process downlink and uplink as described above, separation between Tx and Rx antennas is required. However, existing equipment employs a half-duplex communication scheme and thus alternately uses one single antenna in Tx and Rx processing in many cases.

Therefore, in a full duplex communication scheme in which Tx and Rx are simultaneously processed as in the SBFD technology, the effect of interference is inevitable when a single antenna is used.

In particular, when a beamforming technology for forming a beam for each subscriber by using multiple-input and multiple-output (MIMO) is used in a 5G system environment, the impact of interference caused by a full-duplex communication scheme is even greater.

It is possible to reduce interference by using an existing self-interference cancellation (SIC) function, but completely eliminating interference is actually difficult.

In addition, in order to prevent interference, a method of configuring a guard band between downlink and uplink as illustrated in FIG. 1 described above as an example may also be considered.

However, in such cases, using a wide guard band may actually lead to reduced resource efficiency and a decrease in speed.

Accordingly, an embodiment of the present disclosure is to propose a new method capable of minimizing self-interference occurring between downlink uplink in a full duplex communication environment employing an SBFD technology.

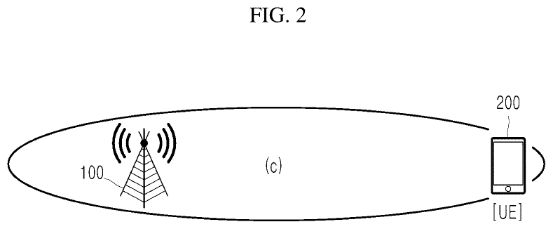

In relation thereto, FIG. 2 shows an example of a full duplex communication environment according to an embodiment of the present disclosure.

As illustrated in FIG. 2, a full duplex communication environment according to an embodiment of the present disclosure may have a configuration including a base station device 100 supporting simultaneous use of uplink and downlink in frequency subbands for a terminal (UE) 200 in a cell coverage C according to application of an SBFD technology.

Such the base station device 100 may be configured to adjust a range of a guard band corresponding to a boundary frequency band between downlink and uplink according to a magnitude of uplink interference.

As described above, in the full duplex communication environment according to an embodiment of the present disclosure, when the SBFD technology is applied, a range of a guard band corresponding to a boundary frequency band between downlink and uplink may be adjusted according to the magnitude of uplink interference so as to minimize self-interference occurring between downlink and uplink.

Hereinafter, the configurations of the base station 100 and the terminal 200 for implementing the above description will be described in more detail.

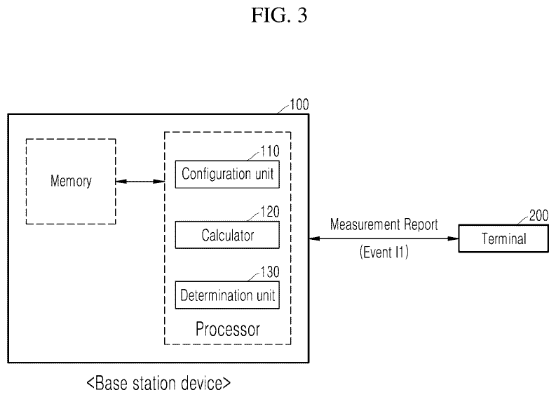

FIG. 3 roughly shows a configuration of a base station device 100 according to an embodiment of the present disclosure.

As described in FIG. 3, the base station device 100 according to an embodiment of the present disclosure may be configured to include a memory including an instruction and a processor configured to execute the instruction in the memory.

In particular, the processor according to an embodiment of the present disclosure may have functional elements including a configuration unit 110, a calculator 120, and a determination unit 130 according to implemented functions executing instruction.

Ultimately, the base station device 100 according to an embodiment of the present disclosure may be configured to adjust the range of a guard band corresponding to a boundary frequency band between downlink and uplink according to the magnitude of uplink interference through the functional elements of the processor described above.

Hereinafter, each functional element of the processor for implementing the above description will be described in more detail.

The configuration unit 110 is configured to be responsible to a function of configuring an event entry condition.

More specifically, the configuration unit 110 is configured to configure a condition for entry into an I1 event (Event I1) and transmit the condition to the terminal 200.

Here, the I1 event (Event I1) is specified in version of TS38.331 Rel16 or higher, and may be understood as an event relating to cross-link interference (CLI), which is interference from downlink to uplink, being measured by a node of the terminal 200.

In relation thereto, the configuration unit 110 is configured to measure ambient interference (noise and interference, NI) in uplink in a state where interference of downlink has been removed, that is, in an idle state of the base station device 100 where a downlink signal is not emitted.

As described above, the configuration unit 110 may be configured to, when ambient interference (noise and interference, NI) is measured in uplink in the idle state of the base station device 100, configure a condition for entry into the I1 event (Event I1), based on the ambient interference measured in uplink.

The configuration unit 110 may be configured to configure the condition for entry into the I1 event (Event I1) by using a threshold of CLI-RSSI as a criterion of event entry in the node of the terminal 200, and an offset value reflected on CLI-RSSI measured by the terminal 200 so as to reduce the ping-pong effect of event entry.

As described above, the configuration unit 110 is configured to, when the condition for entry into the I1 event (Event I1) is configured in the idle state of the base station device 100, transmit the condition for entry into the I1 event (Event I1) to the terminal 200 at the time of switching of the base station device 100 to an active state.

Consequently, according to configuration of the condition for entry into the I1 event (Event I1), when a result value obtained by applying the offset to a currently measured value of CLI-RSSI is equal to or greater than the threshold of CLI-RSSI or exceeds the threshold, the terminal 200 enters the I1 event (Event I1) and transmits (reports) a measured CLI-RSSI value to the base station device 100.

The calculator 120 is configured to be responsible for a function of calculating uplink interference that is interference from downlink to uplink.

More specifically, the calculator 120 is configured to calculate uplink interference that is interference from downlink to uplink, arised from simultaneous use of downlink and uplink in frequency subbands.

The calculator 120 may be configured to calculate uplink interference by using CLI-RSSI measured and reported by the terminal 200 according to entry into a pre-configured I1 event (Event I1).

In other words, according to an event entry condition received from the base station device 100, when a result value obtained by applying an offset to a currently measured value of CLI-RSSI is equal to or greater than a threshold of CLI-RSSI or exceeds the threshold, the node of the terminal 200 enters the I1 event (Event I1) and transmits (reports) a measured CLI-RSSI value to the base station device 100, and the calculator 120 having received same may use the CLI-RSSI value received from the terminal 200 to calculate uplink interference that is current interference from downlink to uplink.

The determination unit 130 is configured to be responsible for a function of adjusting a guard band between downlink and uplink.

More specifically, the determination unit 130 is configured to, when the uplink interference is calculated, differently determine a range of a guard band corresponding to a boundary frequency band between downlink and uplink according to the magnitude of the calculated uplink interference.

The determination unit 130 may be configured to differently determine the range of the guard band through a method of comparing the magnitude of the calculated uplink interference with a threshold configured by an operator.

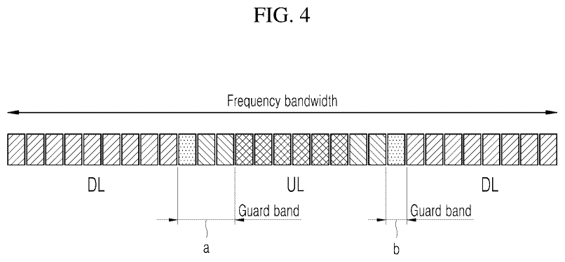

In relation thereto, the determination unit 130 may be configured to, when the magnitude of the uplink interference exceeds the threshold (Interference>Threshold), determine the number of guard band resources (guard band RBs) allocated to the guard band so as to expand the range of the guard band between downlink and uplink, for example, as indicated by reference numeral a in FIG. 4.

The determination unit 130 may be configured to determine the number of guard band resources (guard band RBs) allocable to the guard band, based on the magnitude of the uplink interference, as shown in [Equation 1] below, so as to expand the range of the guard band for uplink.

$$Interference - 10 * log ( Guard band RB ) < 0 \qquad [ Equation 1 ]$$

Here, respective results obtained by converting the magnitude of the uplink interference and the guard band resources (guard band RBs) into 10*log(x) values are expressed by dB values.

On the contrary, the determination unit 130 may be configured to, when the magnitude of the uplink interference is equal to or smaller than the threshold (Interference<=Threshold), determine the number of guard band resources (guard band RBs) allocated to the guard band so as to reduce the range of the guard band between downlink and uplink, for example, as indicated by reference numeral b in FIG. 4.

In relation thereto, the guard band resources (guard band RBs) may not be configured to be larger than RBs used as SBFD.

The determination unit 130 may be configured to determine the number of guard band resources (guard band RBs) allocable to the guard band, based on the magnitude of the uplink interference, as shown in [Equation 2] below, so as to reduce the range of the guard band for uplink.

$$10 * log ( Guard band RB ) - Interference > 0 \qquad [ Equation 2 ]$$

Here, respective results obtained by converting the magnitude of the uplink interference and the guard band resources (guard band RBs) into 10*log (x) values are expressed by dB values similarly to [Equation 1].

Consequently, in an embodiment of the present disclosure, the range of a guard band is determined through allocation of guard band resources (guard band RBs). Therefore, uplink resources (UL arrowed RBs) having minimized uplink interference may be allocated to a remaining resource area obtained by excluding the guard band resources (guard band RBs) from all resources (UL full RBs) allocable to uplink for each slot.

Similarly, the terminal 200 may perform channel configuration only for the remaining resource area obtained by excluding the guard band resources (guard band RBs) from all resources (UL full RBs), thereby supporting interference removal.

Having concluded the description of the configuration of the base station device 100 according to an embodiment of the present disclosure, the configuration of the terminal 200 will be described.

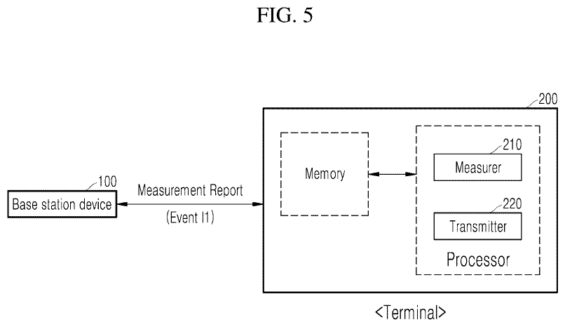

FIG. 5 roughly shows a configuration of the terminal 200 according to an embodiment of the present disclosure.

As described in FIG. 5, the terminal 200 according to an embodiment of the present disclosure may be configured to include a memory including an instruction and a processor configured to execute the instruction in the memory.

In particular, the processor according to an embodiment of the present disclosure may have functional elements including a measurer 210 and a transmitter 220 in accordance with implemented functions according to instruction execution.

Ultimately, the terminal 200 according to an embodiment of the present disclosure may be configured to support adjustment of the range of a guard band corresponding to a boundary frequency band between downlink and uplink according to the magnitude of uplink interference through the functional elements of the processor described above.

Hereinafter, each functional element of the processor for implementing the above description will be described in more detail.

The measurer 210 may be configured to responsible for a function of measuring cross-link interference (CLI)-RSSI.

More specifically, the measurer 210 may be configured to, when downlink and uplink are simultaneously used in frequency subbands, measure a CLI-RSSI value to calculate uplink interference that is interference from the downlink to the uplink.

The measurer 210 may be configured to measure the CLI-RSSI value when a condition for entry into an I1 event (Event I1) configured in the base station device 100 is satisfied.

In relation thereto, in the base station device 100, ambient interference (noise and interference, NI) is measured in uplink in a state where interference of downlink has been removed, that is, in an idle state of the base station device 100 where a downlink signal is not emitted, and a condition for entry into an I1 event (Event 11) based on the measured ambient interference is configured.

Specifically, the base station device 100 may be configured to establish the condition for entry into the I1 event (Event I1) by using a threshold of CLI-RSSI using as a criterion of event entry in the node of the terminal 200, and an offset value reflected on CLI-RSSI measured by the terminal 200 so as to reduce the ping-pong effect of event entry.

Furthermore, the base station device 100 is configured to, when the condition for entry into the I1 event (Event I1) is configured in the idle state thereof as described above, transmit the condition for entry into the I1 event (Event I1) to the terminal 200 at the time of switching to an active state.

Consequently, according to configuration of the condition for entry into the I1 event (Event I1), when a result value obtained by applying an offset to a currently measured value of CLI-RSSI is equal to or greater than a threshold of CLI-RSSI or exceeds the threshold, the measurer 210 enters the I1 event (Event I1) and measures a CLI-RSSI value.

The transmitter 220 may be configured to be responsible for a function of transmitting (reporting) a measured CLI-RSSI value.

More specifically, the transmitter 220 may be configured to, when a CLI-RSSI value is measured, transmit the measured CLI-RSSI value to the base station device 100 to support the base station device 100 to differently determine a range of a guard band corresponding to a boundary frequency band between downlink and uplink according to the magnitude of uplink interference calculated based on the CLI-RSSI value.

In relation thereto, the base station device 100 is configured to calculate uplink interference, which is current interference from downlink to uplink, by using CLI-RSSI measured and reported by the terminal 200 according to entry into a pre-configured I1 event (Event I1).

In addition, the base station device 100 is configured to, when the uplink interference is calculated, differently determine the range of the guard band through a method of comparing the magnitude of the uplink interference with a threshold configured by an operator.

That is, the determination unit 100 may be configured to, when the magnitude of the uplink interference exceeds the threshold (Interference>Threshold), determine the number of guard band resources (guard band RBs) allocated to the guard band so as to expand the range of the guard band between downlink and uplink, as indicated by reference numeral a in FIG. 4 described above as an example.

On the contrary, the base station device 100 may be configured to, when the magnitude of the uplink interference is equal to or smaller than the threshold (Interference<=Threshold), determine the number of guard band resources (guard band RBs) allocated to the guard band so as to reduce the range of the guard band between downlink and uplink, as indicated by reference numeral b in FIG. 4 described above as an example.

Consequently, in an embodiment of the present disclosure, the range of a guard band is determined through allocation of guard band resources (guard band RBs). Therefore, uplink resources (UL arrowed RBs) having minimized uplink interference may be allocated to a remaining resource area obtained by excluding the guard band resources (guard band RBs) from all resources (UL full RBs) allocable to uplink for each slot.

In relation thereto, even the node of the terminal 200 according to an embodiment of the present disclosure may perform channel configuration only for the remaining resource area obtained by excluding the guard band resources (guard band RBs) from all resources (UL full RBs), so as to support the above interference removal.

In other words, the base station device 100 designates resources (RBs) required to be used by the node of the terminal 200, but independently to the designation, the node of the terminal 200 may not use resources in a guard band resource (guard band RB) area when transmitting a signal such as an SRS, thereby supporting interference removal together.

Ultimately, the measurer 210 excludes guard band resources (guard band RBs) from resources for measurement of a CLI-RSSI value, and similarly, the transmitter 220 excludes guard band resources (guard band RBs) from resources for transmission (reporting) of a CLI-RSSI value, thereby supporting minimization of self-interference (SI) occurring between downlink and uplink.

As discussed above, it may be noted that in accordance with the configurations of the base station device 100 and the terminal 200 according to an embodiment of the present disclosure, when a subband non-overlapping full duplex (SBFD) technology is applied, a range of a guard band corresponding to a boundary frequency band between downlink and uplink may be adjusted according to the magnitude of uplink interference, thereby minimizing self-interference (SI) occurring between downlink and uplink and accordingly enabling to ensure the capacity and latency of the base station device 100 and sufficient uplink coverage.

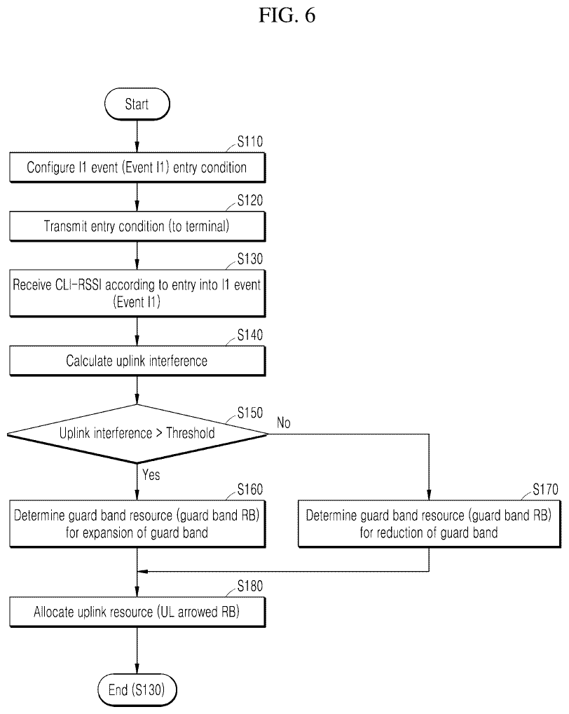

Hereinafter, an interference removal method according to an embodiment of the present disclosure will be described with reference to FIG. 6.

For convenience of explanation, in the following description, the base station device 100 described above with reference to FIG. 3 is mentioned as a subject which performs the interference removal method.

First, the base station device 100 configures a condition for entry into an I1 event (Event I1) and transmits the condition to the terminal 200 (operations S110 and S120).

Here, the I1 event (Event I1) is specified in version of TS38.331 Rel16 or higher, and may be understood as an event relating to cross-link interference (CLI), which is interference from downlink to uplink, being measured by a node of the terminal 200.

In relation thereto, the base station device 100 measures ambient interference (noise and interference, NI) in uplink in a state where interference of downlink has been removed, that is, in an idle state of the base station device 100 where a downlink signal is not emitted.

As described above, when ambient interference (noise and interference, NI) is measured in uplink in the idle state of the base station device 100, the base station device 100 configures a condition for entry into the I1 event (Event I1), based on the ambient interference measured in uplink.

The base station device 100 may configure the condition for entry into the I1 event (Event I1) by using a threshold of CLI-RSSI as a criterion of event entry in the node of the terminal 200, and an offset value reflected on CLI-RSSI measured by the terminal 200 so as to reduce the ping-pong effect of event entry.

As described above, when the condition for entry into the I1 event (Event I1) is configured in the idle state thereof, the base station device 100 transmits the condition for entry into the I1 event (Event I1) to the terminal 200 at the time of switching to an active state.

Consequently, according to configuration of the condition for entry into the I1 event (Event I1), when a result value obtained by applying the offset to a currently measured value of CLI-RSSI is equal to or greater than the threshold of CLI-RSSI or exceeds the threshold, the terminal 200 enters the I1 event (Event I1) and transmits (reports) a measured CLI-RSSI value to the base station device 100.

Furthermore, the base station device 100 calculates uplink interference that is interference from downlink to uplink, arised from simultaneous use of downlink and uplink in frequency subbands (operations S130 and S140).

The base station device 100 may calculate uplink interference by using CLI-RSSI measured and reported by the terminal 200 according to entry into the pre-configured I1 event (Event I1).

In other words, according to an event entry condition received from the base station device 100, when a result value obtained by applying an offset to a currently measured value of CLI-RSSI is equal to or greater than a threshold of CLI-RSSI or exceeds the threshold, the node of the terminal 200 enters the I1 event (Event I1) and transmits (reports) a measured CLI-RSSI value to the base station device 100, and the base station device 100 having received same may use the CLI-RSSI value received from the terminal 200 to calculate uplink interference that is current interference from downlink to uplink.

Thereafter, when the uplink interference is calculated, the base station device 100 differently determines a range of a guard band corresponding to a boundary frequency band between downlink and uplink according to the magnitude of the calculated uplink interference.

The base station device 100 may differently determine the range of the guard band through a method of comparing the magnitude of the calculated uplink interference with a threshold configured by an operator.

In relation thereto, when the magnitude of the uplink interference exceeds the threshold (Interference>Threshold), the base station device 100 may determine the number of guard band resources (guard band RBs) allocable to the guard band, based on the magnitude of the uplink interference so as to expand the range of the guard band between downlink and uplink as indicated by reference numeral a in FIG. 4 described above as an example (operations S150 and S160).

On the contrary, when the magnitude of the uplink interference is equal to or smaller than the threshold (Interference<=Threshold), the base station device 100 may determine the number of guard band resources (guard band RBs) allocable to the guard band, based on the magnitude of the uplink interference so as to reduce the range of the guard band between downlink and uplink, as indicated by reference numeral b in FIG. 4 described above as an example (operations S150 and S170).

Consequently, the base station device 100 determines the range of a guard band through allocation of guard band resources (guard band RBs) as described above, and thus may allocate, as uplink resources (UL arrowed RBs) having minimized uplink interference, a resource area obtained by excluding the guard band resources (guard band RBs) from all resources (UL full RBs) allocable to uplink for each slot (operation S180).

As discussed above, it may be noted that according to the interference removal method according to an embodiment of the present disclosure, when a subband non-overlapping full duplex (SBFD) technology is applied, a range f a guard band corresponding to a boundary frequency band between downlink and uplink may be adjusted according to the magnitude of uplink interference, thereby minimizing self-interference (SI) occurring between downlink and uplink and accordingly ensuring the capacity and latency of the base station device 100 and sufficient uplink coverage.

The interference removal method according to an embodiment of the present disclosure may be implemented in a form of program command that may be configured to be executed through various computer means and recorded on a computer readable medium. The computer readable medium may include program commands, data files, data structures, etc. alone or in combination. Program commands recorded on the medium may be specially designed and configured for the present disclosure or known and usable to those skilled in computer software. Examples s of computer-readable recording media include magnetic media such as hard disks, floppy disks, and magnetic tapes, optical media such as CD-ROMs and DVDs, magneto-optical media such as floptical disks, and hardware devices specially configured to store and execute program commands, such as ROM, RAM, flash memory, and the like. Examples of program commands include high-level language codes that may be executed by a computer using an interpreter, as well as machine language codes produced by a compiler. The aforementioned hardware device may be configured to function as one or more software modules to perform the operations of the present disclosure, and vice versa.

Although the present disclosure has been described in detail with reference to preferred embodiments, the present disclosure is not limited to the above-described embodiments, and the technical idea of the present disclosure extends to the extent that any person with ordinary knowledge in the technical field to which the present disclosure belongs may make various changes or modifications without departing from the gist of the present disclosure claimed in the following claims.

1. A base station device comprising:
a memory including an instruction; and
a processor,
wherein the processor is configured to, by executing the instruction:
calculate uplink interference that is interference from a downlink to an uplink, arised from simultaneous use of the downlink and the uplink in frequency subbands; and
differently determine a range of a guard band corre-sponding to a boundary frequency band between the downlink and the uplink according to a magnitude of the uplink inter-ference.

2. The base station device of claim 1, wherein the uplink interference is calculated based on a cross-link interference (CLI)-RSSI measured and reported by a terminal according to an entry into a pre-configured I1 event (Event I1).

3. The base station device of claim 2, wherein the processor is configured to establish a condition for en-try into the I1 event (Event I1) and provide the condition to the terminal, and
wherein the condition for entry is configured based on ambient interference measured in the uplink in an idle state of the base station device, which is a state where interfer-ence of the downlink has been removed.

4. The base station device of claim 1, wherein the processor is configured to:
in case that the magnitude of the uplink interference exceeds a threshold, determine the number of guard band re-sources (guard band RBs) allocable to the guard band, based on the magnitude of the uplink interference in order to ex-pand the guard band; and
in case that the magnitude of the uplink interference is smaller than the threshold, determine the number of guard band resources (guard band RBs) allocable to the guard band, based on the magnitude of the uplink interference in order to reduce the guard band.

5. A terminal comprising:
a memory including an instruction; and
a processor,
wherein the processor is configured to, by executing the instruction:
in case that a downlink and an uplink are simultaneously used in frequency subbands, for calculation of uplink interference that is interference from the downlink to the uplink, measure a cross-link interference (CLI)-RSSI value; and
transmit the CLI-RSSI value to a base station device so as to support the base station device to differently de-termine a range of a guard band corresponding to a boundary frequency band between the downlink and the uplink according to a magnitude of the uplink interference calculated based on the CLI-RSSI value, and
wherein a resource in the guard band is excluded from resources for measurement and transmission of the CLI-RSSI value.

6. An interference removal method performed by a base station device, the method comprising:
calculating uplink interference that is interference from a downlink to an uplink, arised from simultaneous use of the downlink and the uplink in frequency subbands; and
differently determining a range of a guard band corre-sponding to a boundary frequency band between the downlink and the uplink according to a magnitude of the uplink inter-ference.

7. The interference removal method of claim 6, wherein the uplink interference is calculated based on a cross-link interference (CLI)-RSSI measured and reported by a terminal according to an entry into a pre-configured I1 event (Event I1).

8. The interference removal method of claim 7, further comprising configuring a condition for entry into the I1 event (Event I1) to provide the condition to the ter-minal,
wherein the condition for entry is configured based on ambient interference measured in the uplink in an idle state of the base station device, which is a state where interfer-ence of the downlink has been removed.

9. The interference removal method of claim 6, wherein the determining comprises:
in case that the magnitude of the uplink interference exceeds a threshold, determining the number of guard band resources (guard band RBs) allocable to the guard band, based on the magnitude of the uplink interference in order to expand the guard band; and
in case that the magnitude of the uplink interference is smaller than the threshold, determining the number of guard band resources (guard band RBs) allocable to the guard band, based on the magnitude of the uplink interference in order to reduce the guard band.

10. A computer-readable recording medium record-ing a program for executing the method of claim 6.

11. A computer program stored in a medium to be coupled to hardware to execute the method of claim 6.

12. A computer-readable recording medium record-ing a program for executing the method of claim 7.

13. A computer-readable recording medium record-ing a program for executing the method of claim 8.

14. A computer-readable recording medium record-ing a program for executing the method of claim 9.

15. A computer program stored in a medium to be coupled to hardware to execute the method of claim 7.

16. A computer program stored in a medium to be coupled to hardware to execute the method of claim 8.

17. A computer program stored in a medium to be coupled to hardware to execute the method of claim 9.
